(19) United States
(12) Patent Application Publication
(10) Pub. No.: US 2024/0367496 A1
(43) Pub. Date: Nov. 7, 2024

(54) VEHICLE COVER SYSTEMS AND METHODS

(71) Applicant: TOPLESS RAINCOAT, LLC, Bacliff, TX (US)

(72) Inventors: Veronica Brown, Bacliff, TX (US); Mason Gregory Brown, Bacliff, TX (US)

(21) Appl. No.: 18/655,258

(22) Filed: May 5, 2024

Related U.S. Application Data
(60) Provisional application No. 63/464,480, filed on May 5, 2023.

(51) Int. Cl. B60J 11/04

(52) U.S. Cl. CPC B60J 11/04

(57) ABSTRACT

A vehicle cover system is provided that is portable, transparent, quickly applied by a user, and provides interior protection while allowing the vehicle to continue traveling. The cover system provides protection from environmental elements when the vehicle has all its doors, windows, and rooftop removed. Methods of installing the cover system are also disclosed.

### CROSS-REFERENCE TO RELATED APPLICATIONS

This is a Nonprovisional U.S. Patent Application filed under 35 U.S.C. 111(a), claiming the benefit of Provisional U.S. Patent Application Ser. No. 63/464,480, filed May 5, 2023.

### BACKGROUND OF THE INVENTION

### 1. Field of the Invention

The present invention relates generally to vehicle cover systems and methods for protecting the interior of vehicles while the vehicle is being driven or stationary. More particularly, the present invention relates to portable unitary vehicle covers that can be attached to vehicles with removable doors, windows, and rooftops.

### 2. Description of Related Art

Convertible roof sport utility vehicles (SUVs) are designed to give occupants a feeling of openness and exposure to nature while traveling. Complete removal of the vehicle's roof and doors is often desirable, and also improves visibility of the external environment for occupants. Most of these convertible sport utility vehicles are used under changing driving conditions. Thus, although a removable roof may be desirable for recreational driving conditions, it may be necessary to reconfigure the roof for other use conditions encountered in the same trip, including inclement weather and rain.

A very popular type of convertible SUV is a Jeep vehicle. Other examples of convertible SUVs are Broncos, Range Rovers, and the like. These vehicles are often equipped with a unitary hard top that is removable to expose passengers to the open environment. Because removal and storage of the hard top are typically time consuming and difficult, the unitary top does not provide a practical solution for reconfiguring the roof to accommodate changing driving conditions.

Many conventional covers are designed to completely cover the outside of the vehicle, including fastening systems that are not compatible for use with vehicles having roll bars. Although conventional covers have been developed for use with vehicles to help shield the interior of the vehicle, such devices are either cumbersome to install, are not very practical or user-friendly, or are used to cover a small area of the vehicle, thus providing limited applicability. Some cover systems are designed to protect the interior, but are not transparent and do not allow the vehicle to continue traveling with the systems installed.

Thus, there is a strong need in the field for a vehicle cover system and method that is portable, quickly applied, and provides interior protection while allowing the vehicle to continue traveling.

### DETAILED DESCRIPTION OF THE INVENTION

The following descriptions relate to preferred embodiments, although it should be understood that many other alternative embodiments would also fall within the scope of the invention. The embodiments disclosed are not to be construed as describing limits to the invention, whereas the broader scope of the invention should instead be considered with reference to the claims, which may be now appended or may later be added or amended in this or related applications. Any “examples” described herein are non-limiting. Unless indicated otherwise, it is to be understood that terms used in these descriptions generally have the same meanings as those that would be understood by persons of ordinary skill in the art. As described herein, the term “vehicle” may include any vehicle where users or occupants may wish to protect the interior of the vehicle from rain, sun, or provide privacy. For example, a “vehicle” can have one or more roll bars, one or more removable doors, rooftops, and windows. Example “vehicles” can include Jeeps, Broncos, Range Rovers, or any other convertible sport utility vehicles.

For purposes of these descriptions, a few wording simplifications should be understood as universal, except to the extent otherwise clarified in a particular context either in the specification or in particular claims. The use of the term “or” should be understood as referring to alternatives, although it is generally used to mean “and/or” unless explicitly indicated to refer to alternatives only, or unless the alternatives are inherently mutually exclusive. Furthermore, unless explicitly dictated by the language, the term “and” may be interpreted as “or” in some instances. When referencing values, the term “about” may be used to indicate an approximate value, generally one that could be read as being that value plus or minus half of the value. “A” or “an” and the like may mean one or more, unless clearly indicated otherwise. Such “one or more” meanings are most especially intended when references are made in conjunction with open-ended words such as “having,” “comprising” or “including.” Likewise, “another” object may mean at least a second object or more. As used herein, the use of “may” or “may be” indicates that a modified term is appropriate, capable, or suitable for an indicated capacity, function, or usage, while considering that in some circumstances the modified term may sometimes not be appropriate, capable, or suitable. “Plurality” refers to two or more devices or components. It should be understood that dimensions (lengths, widths, heights, etc.) of the invention can vary, and any specific dimensions recited are merely non-limiting examples.

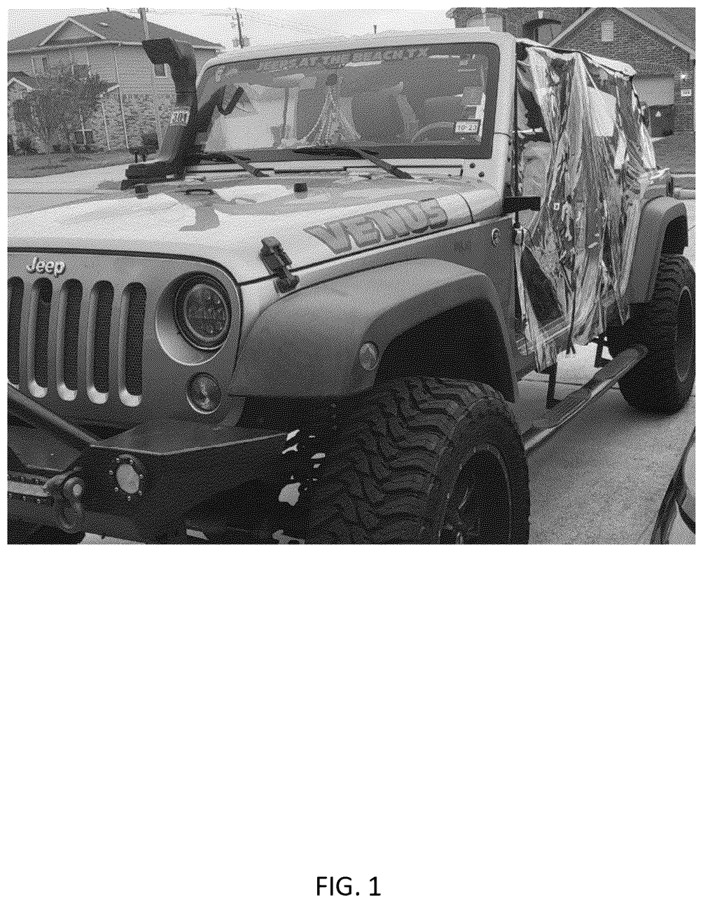

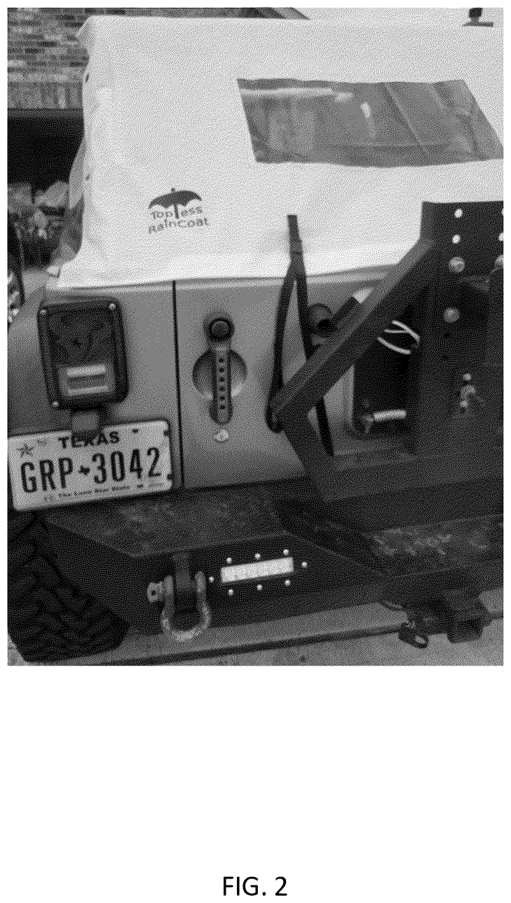

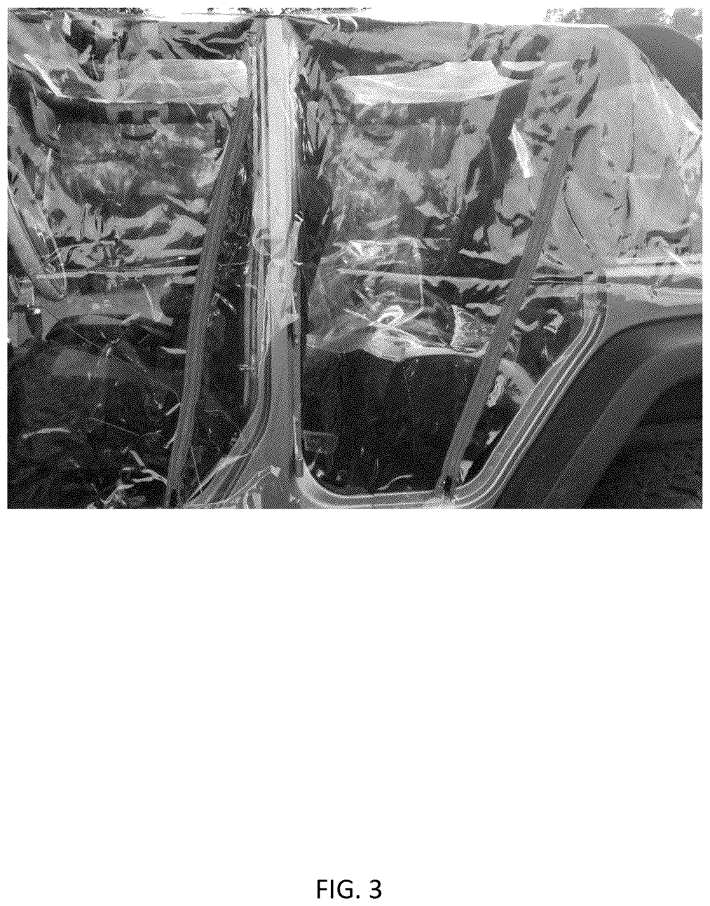

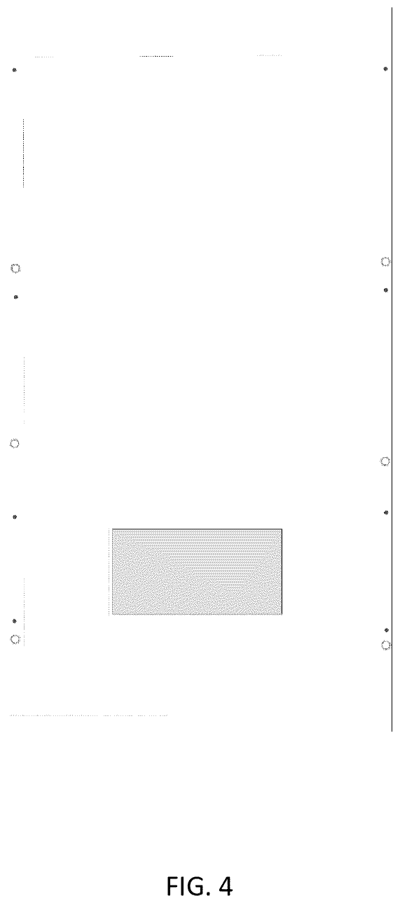

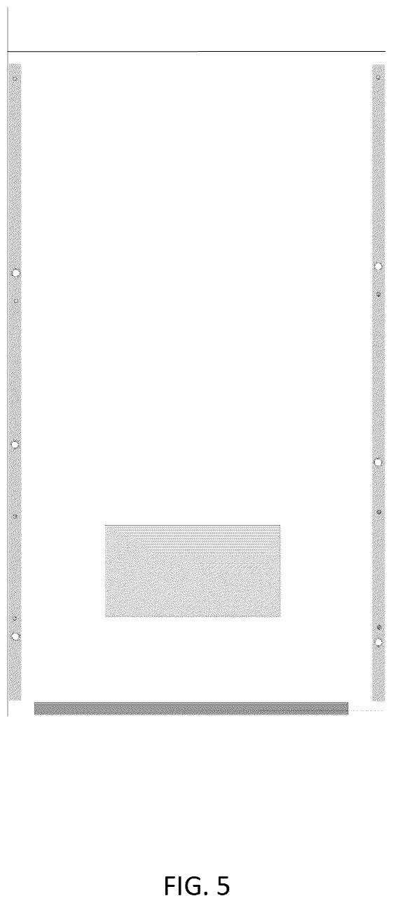

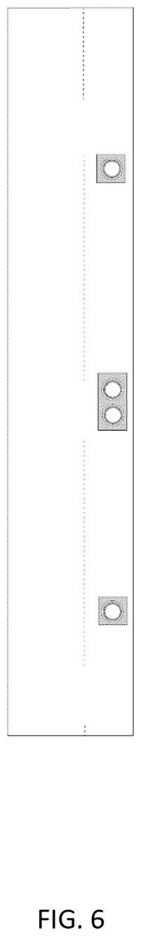

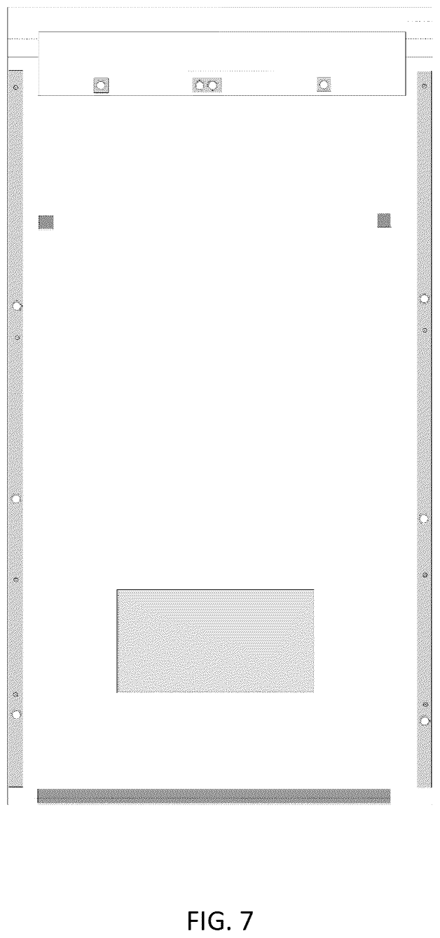

FIG. 1 illustrates a front perspective view of a vehicle 60 with a cover system 10 installed. The cover system 10 provides protection from environmental elements when the vehicle 60 has all its doors, windows, and rooftop removed. FIG. 2 illustrates a rear perspective view of the vehicle 60 with the cover system 10 attached. FIG. 3 illustrates a left side view of the cover system 60, revealing zipper attachments enabling a user to open and close the cover for entry and exit. FIG. 4 illustrates a top view of a cover 101, showing the exterior side of the cover 101 that is facing away from the vehicle. FIG. 5 illustrates a bottom view of the cover 101, showing the interior side of the cover 101 that is facing toward the vehicle. FIG. 6 illustrates a panel with grommets that can be attached to the cover 101. FIG. 7 illustrates a bottom view of the cover 101 with a panel attached at the front. The panel can be sewn on to the cover 101 or attached by other means.

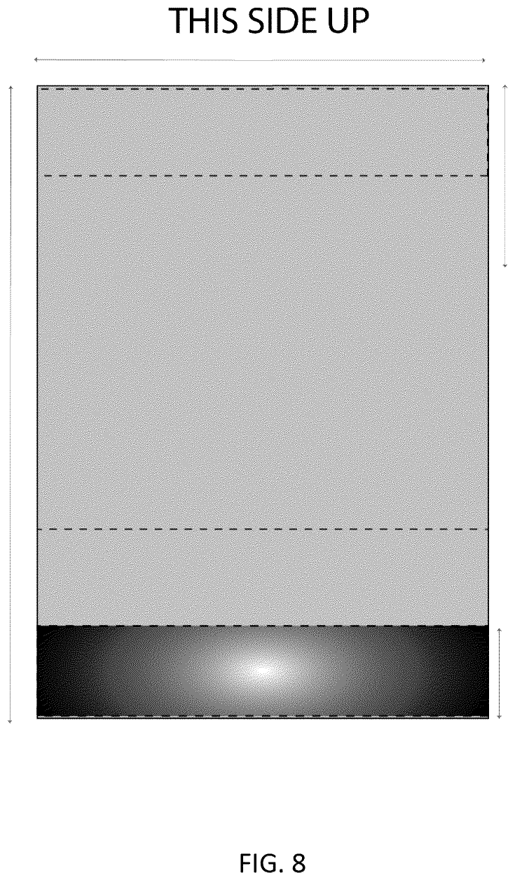

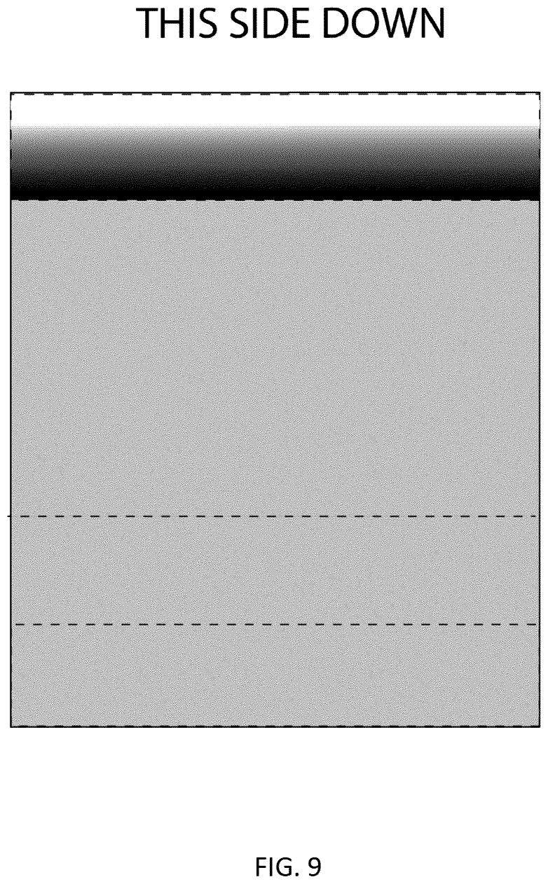

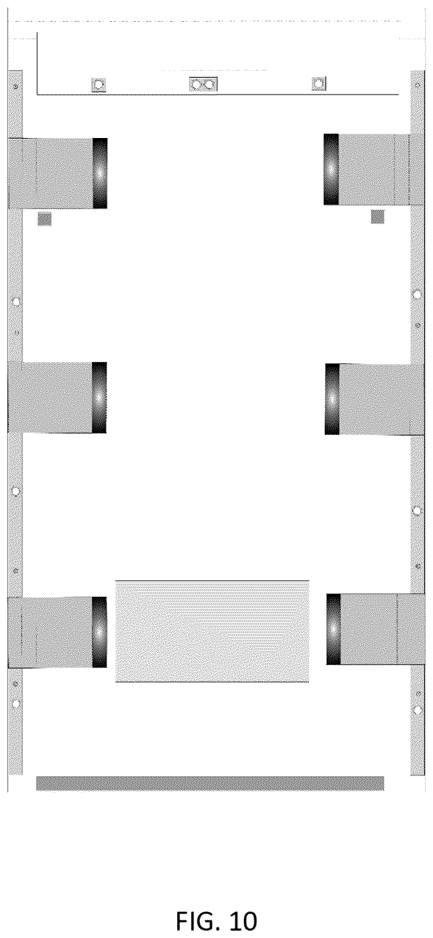

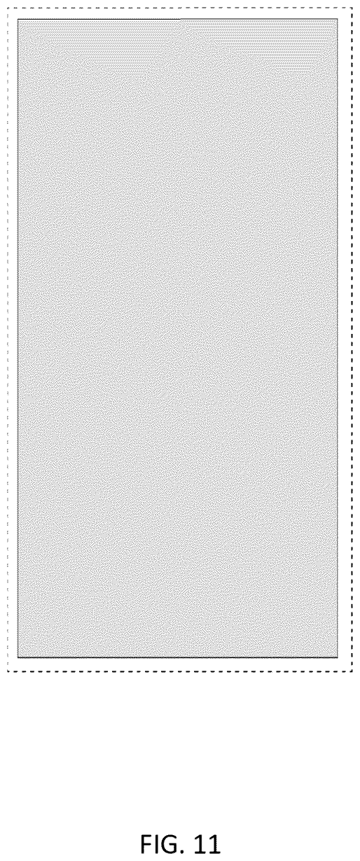

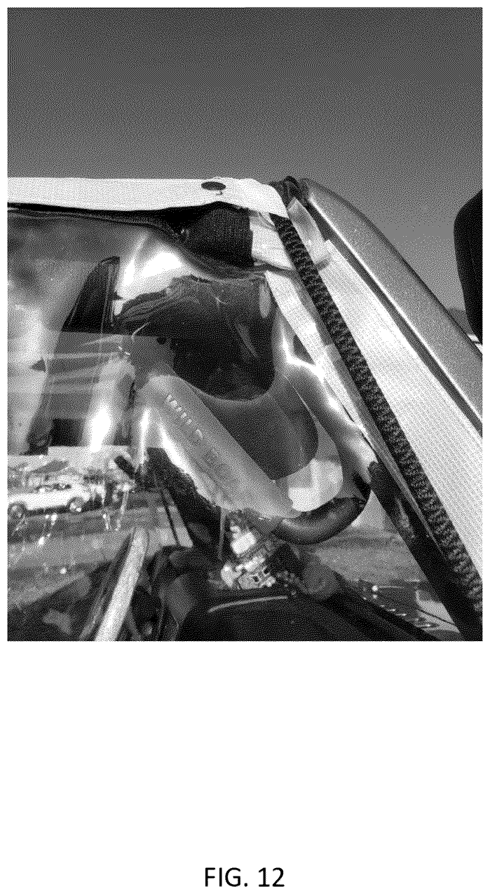

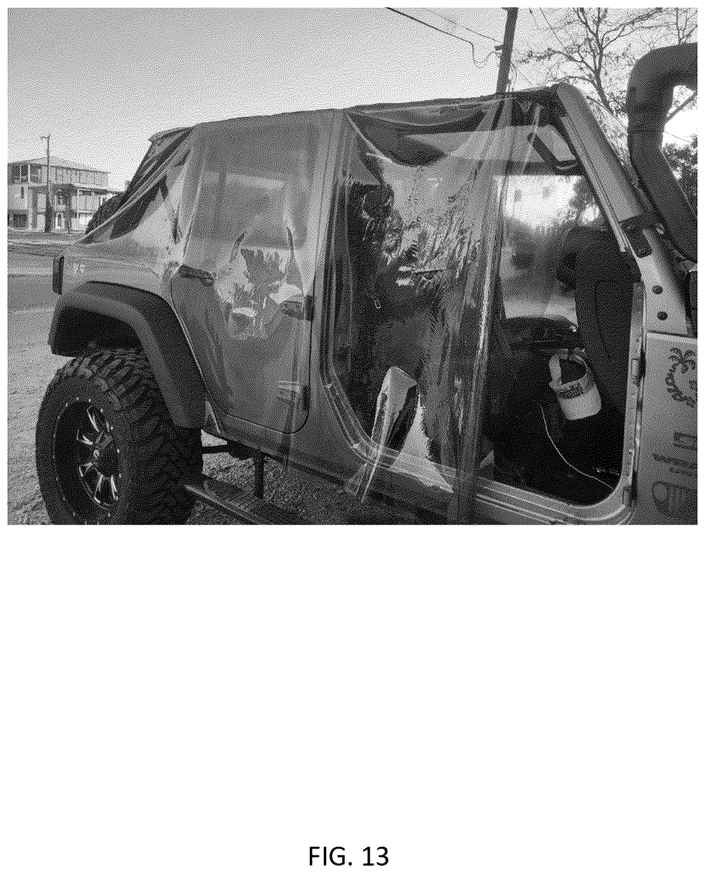

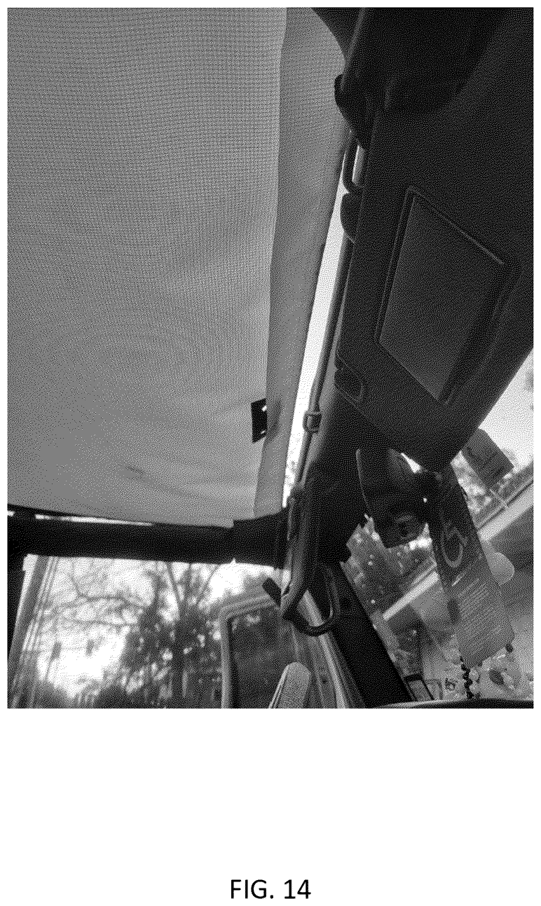

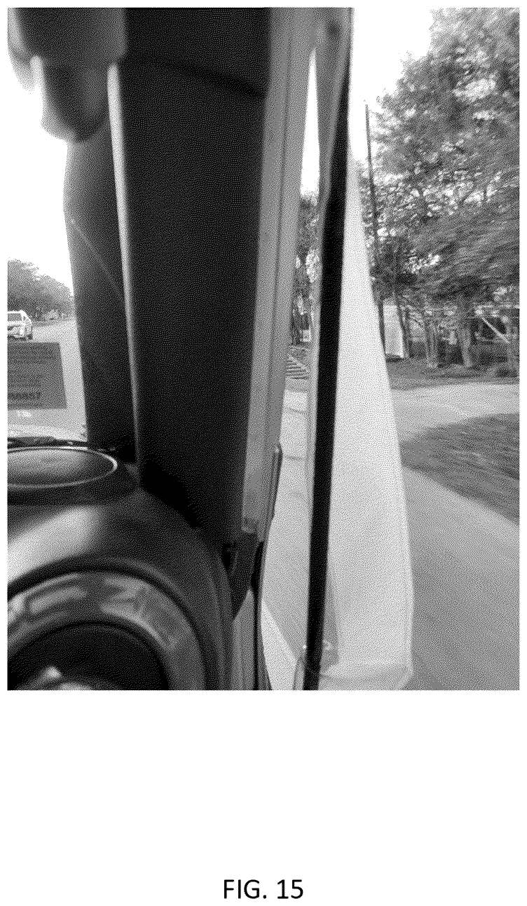

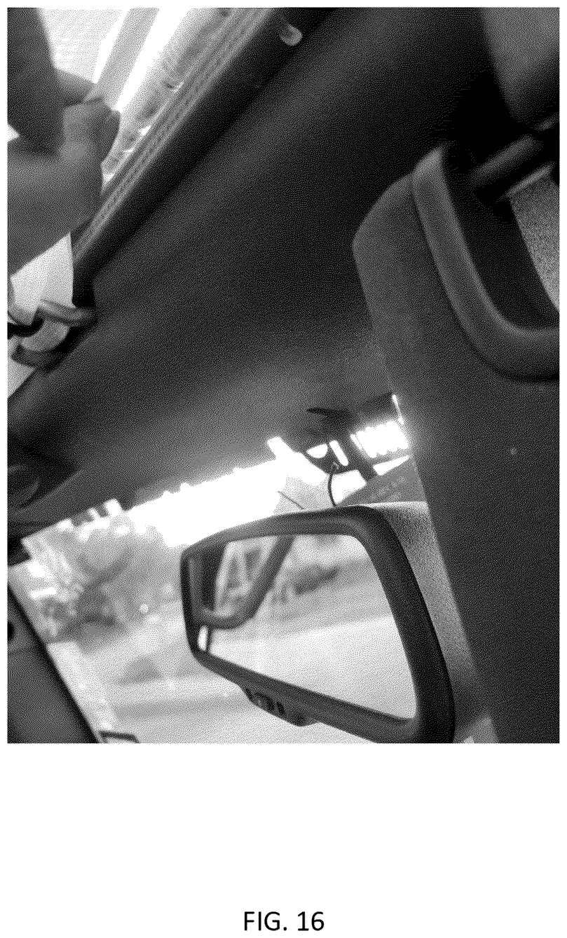

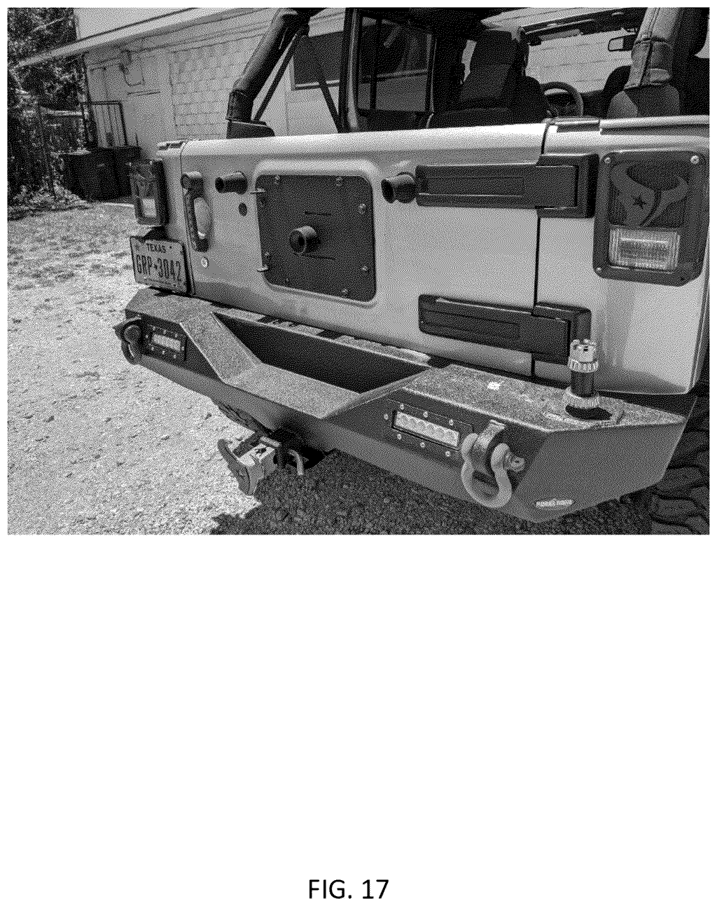

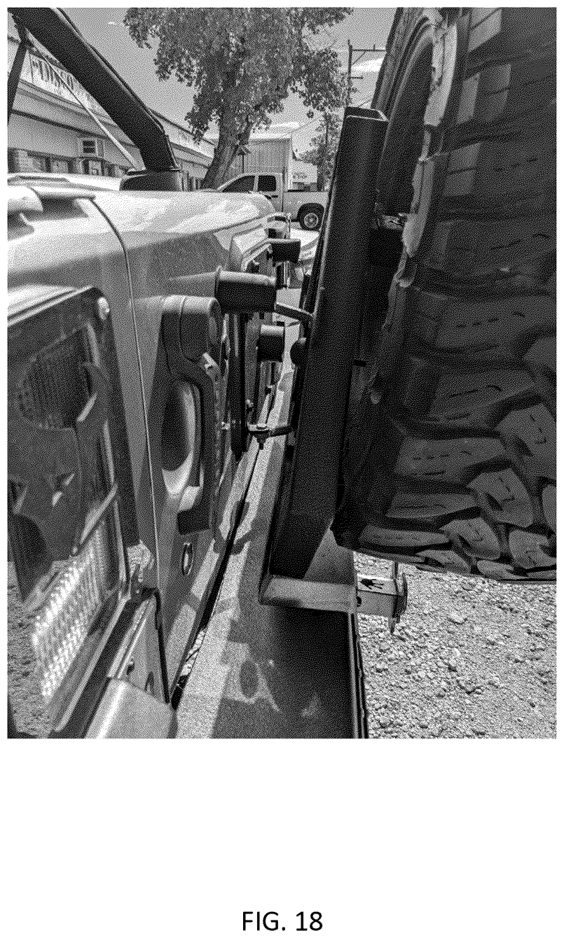

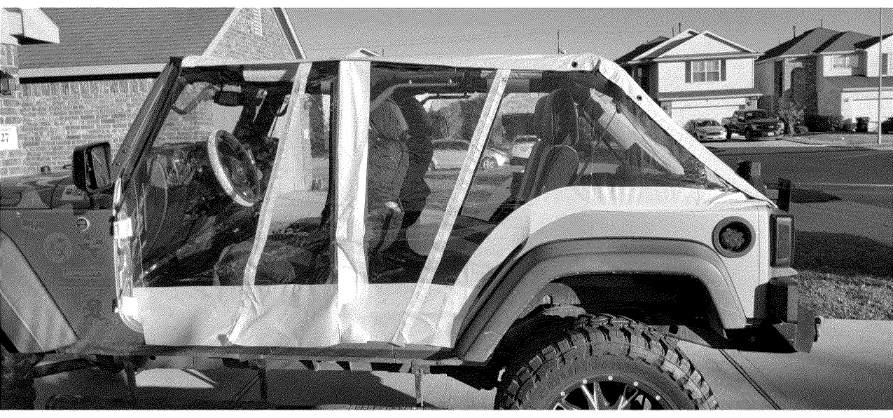

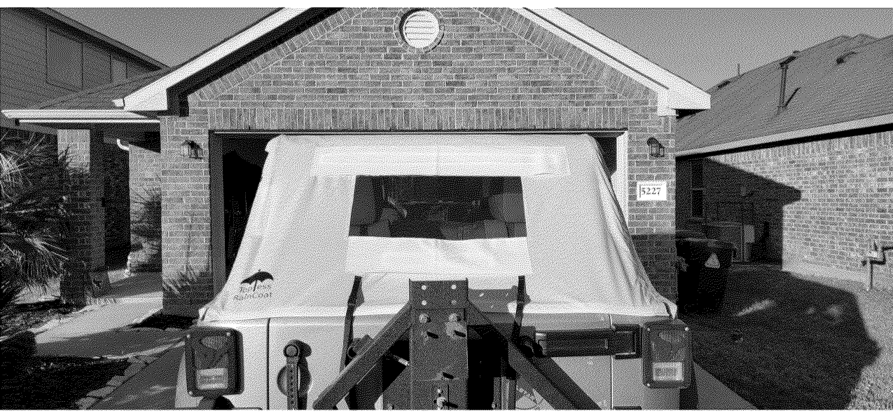

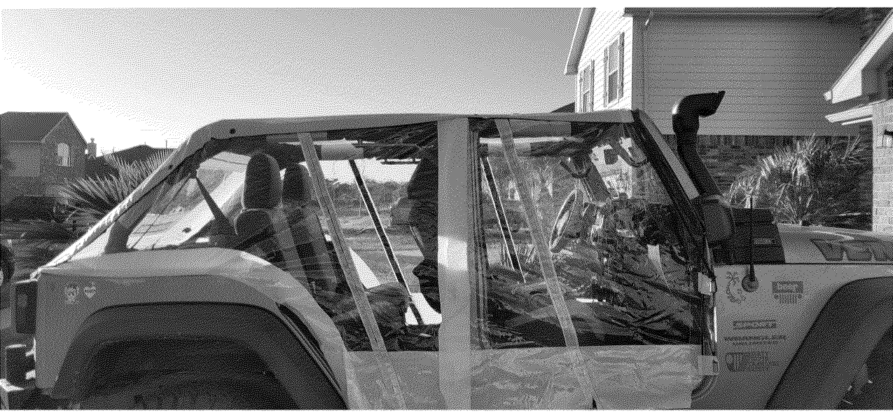

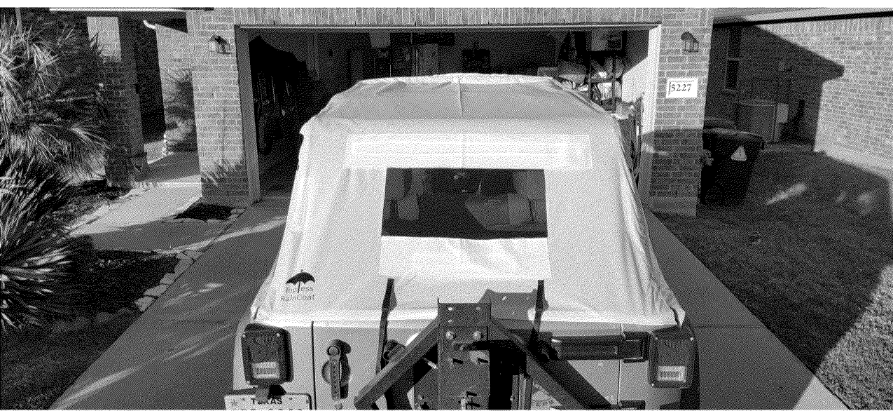

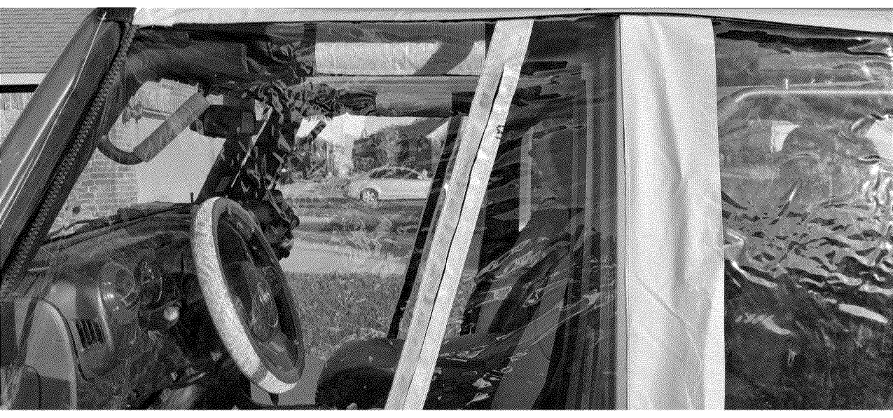

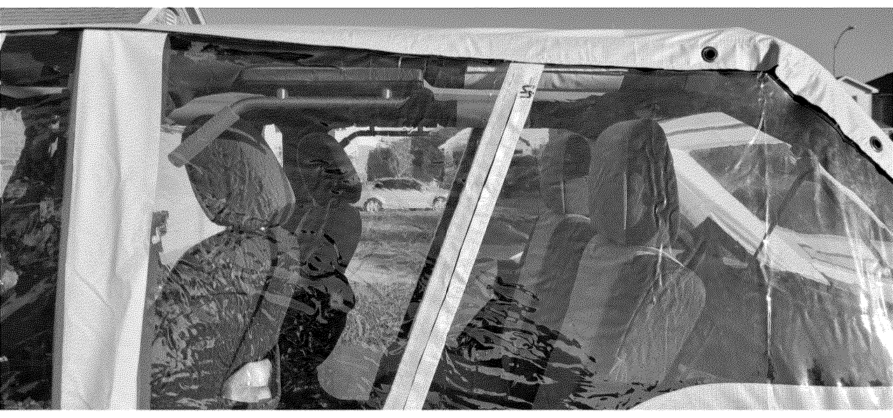

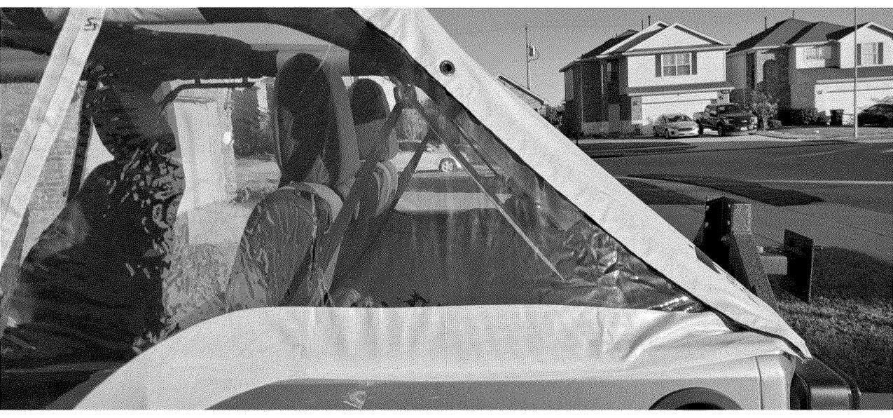

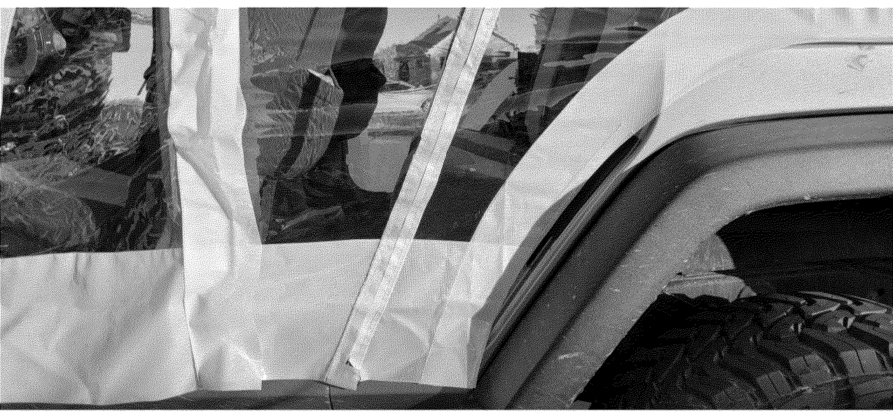

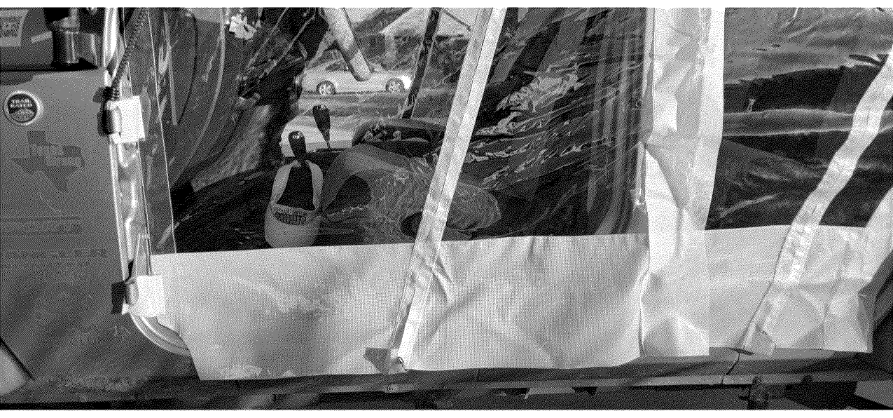

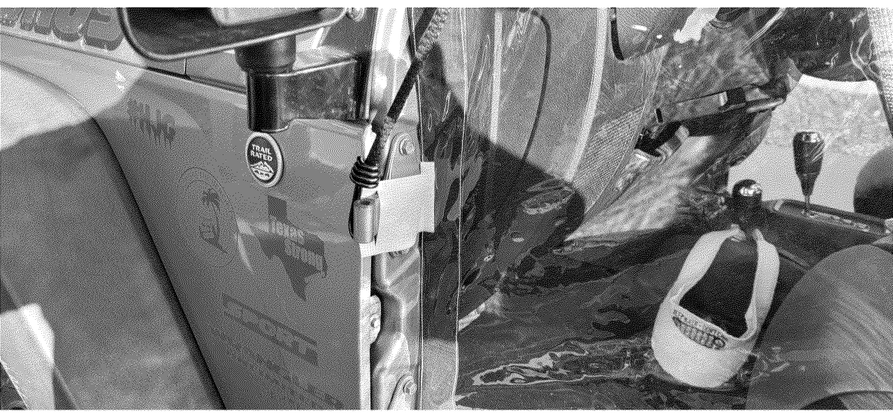

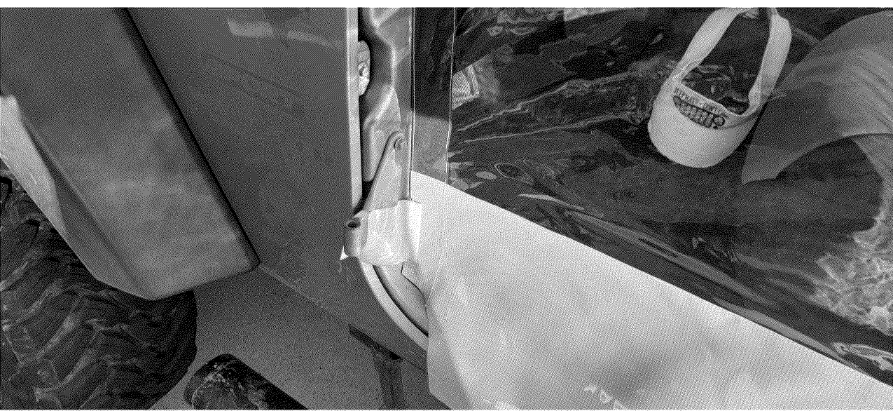

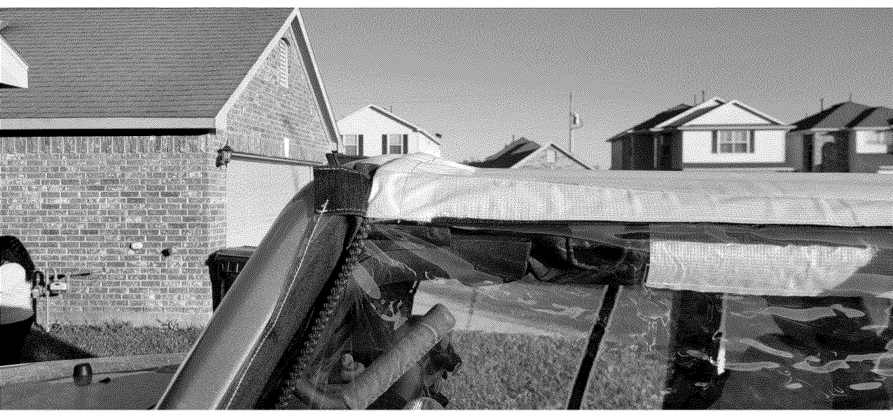

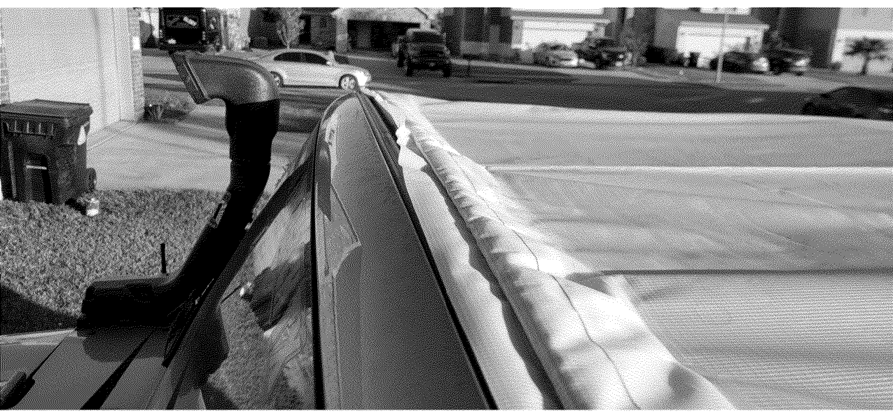

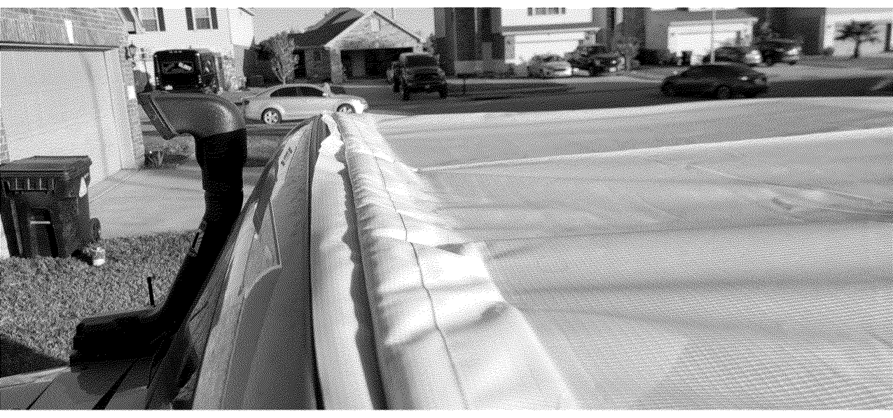

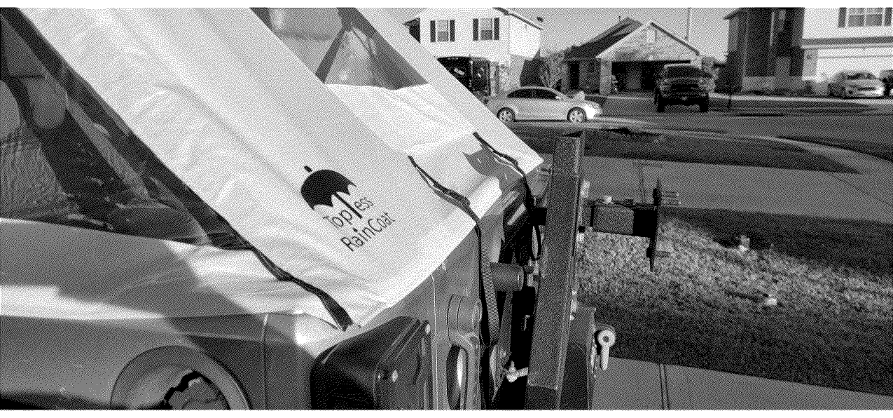

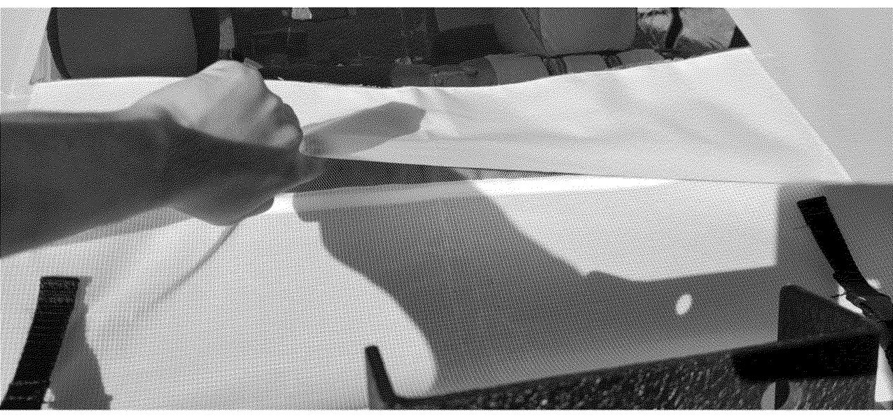

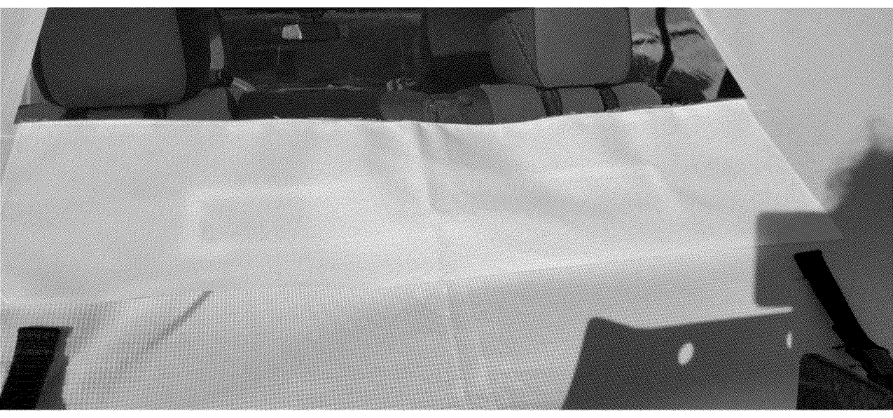

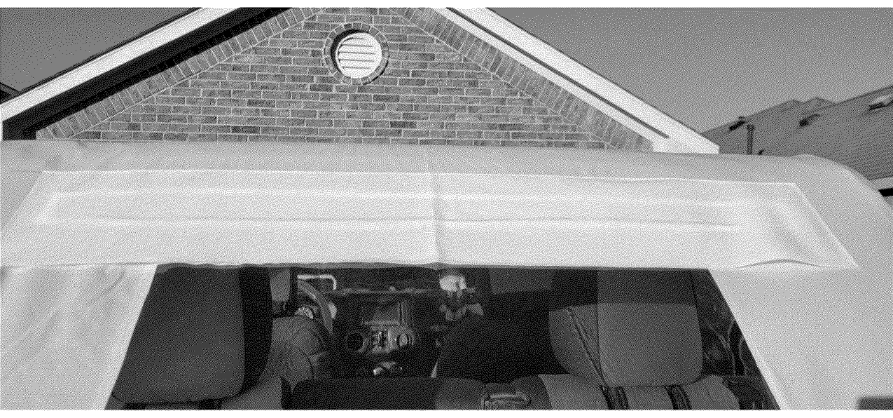

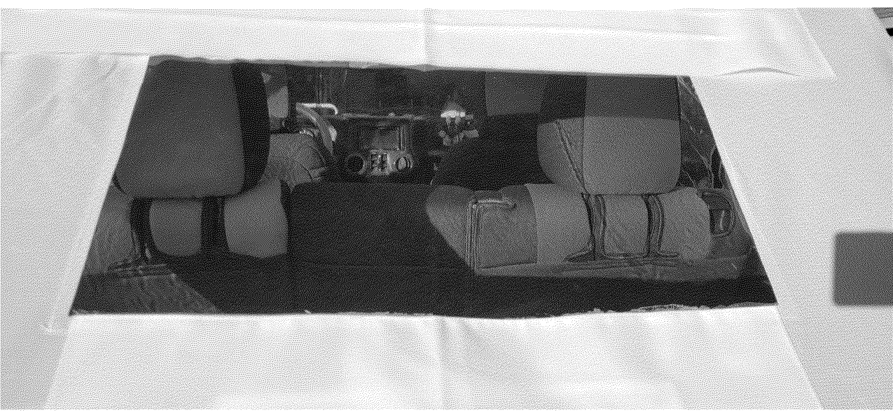

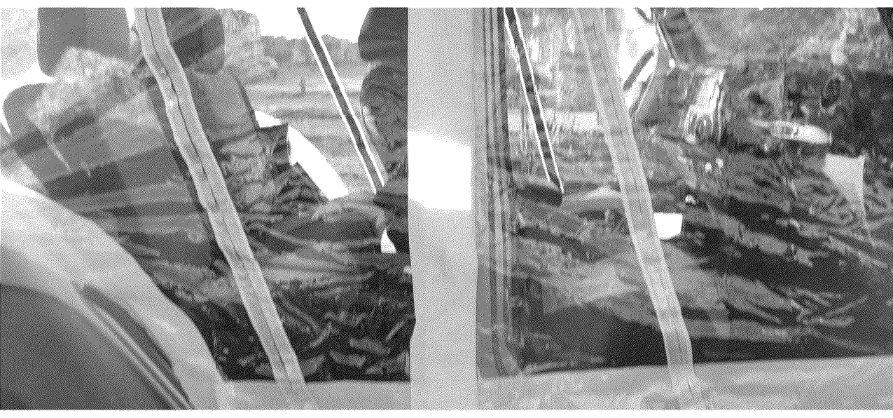

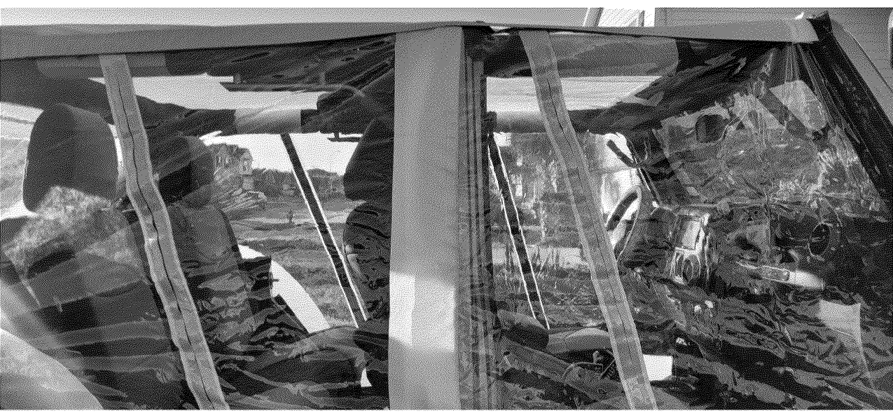

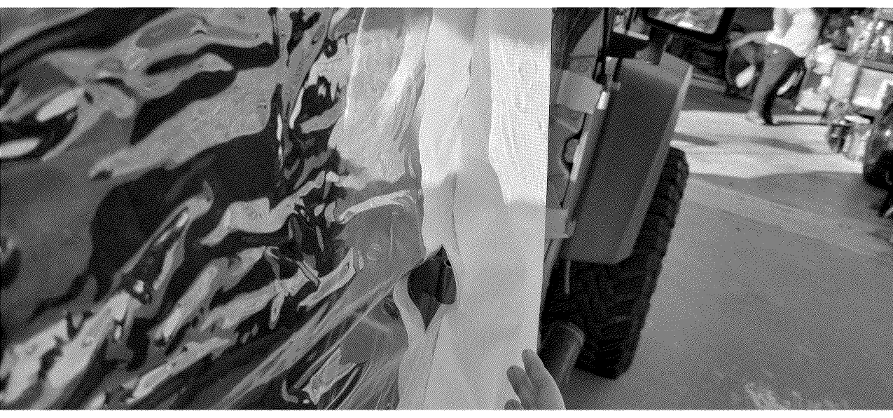

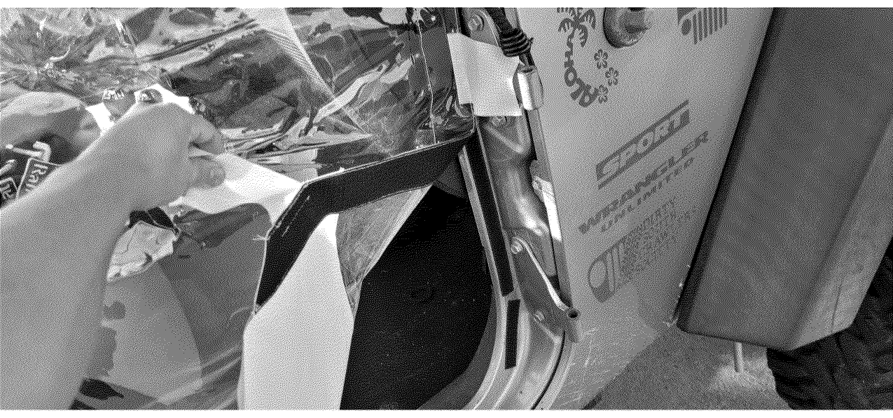

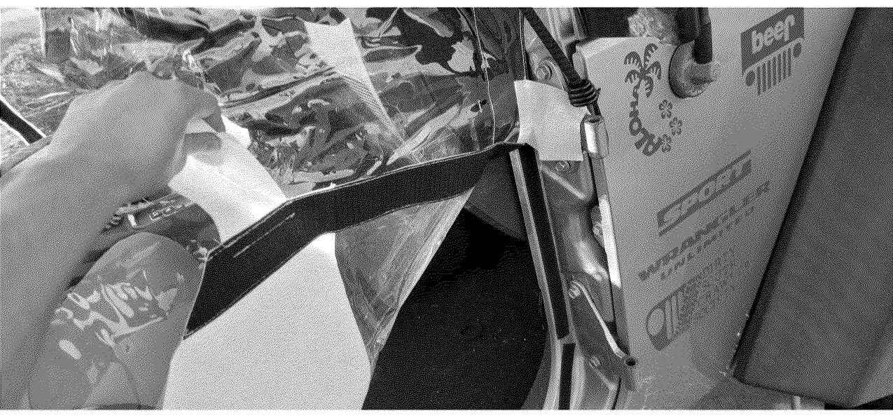

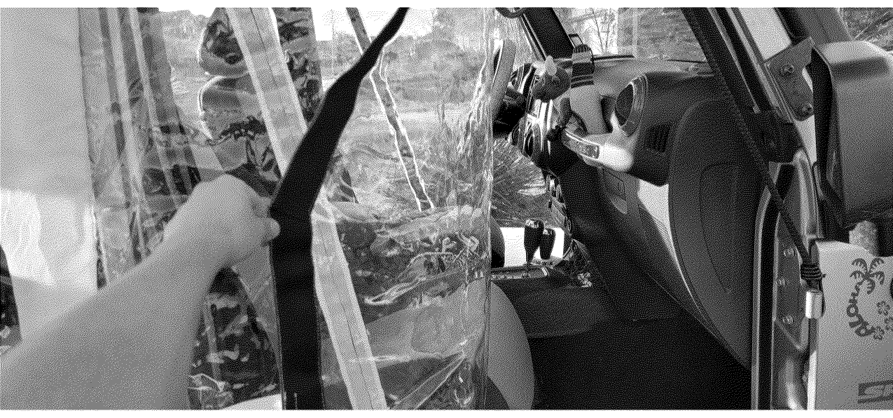

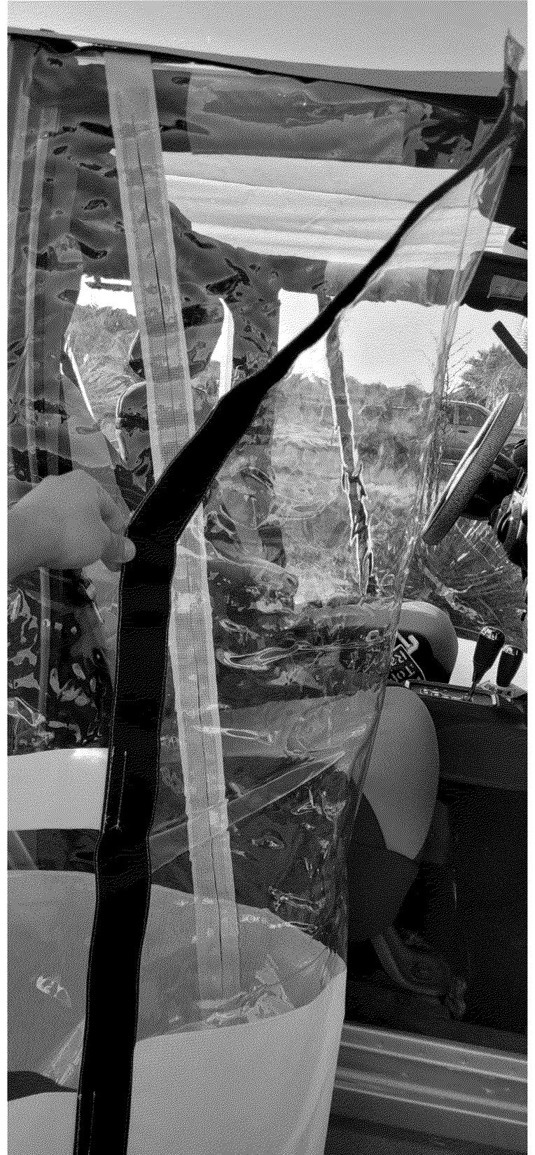

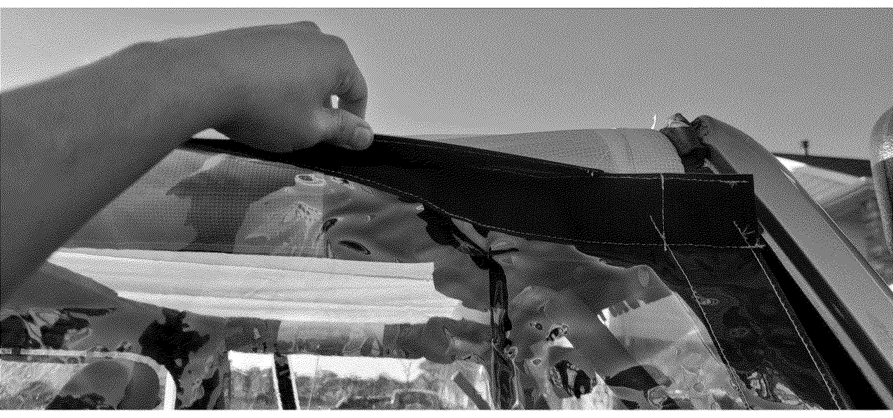

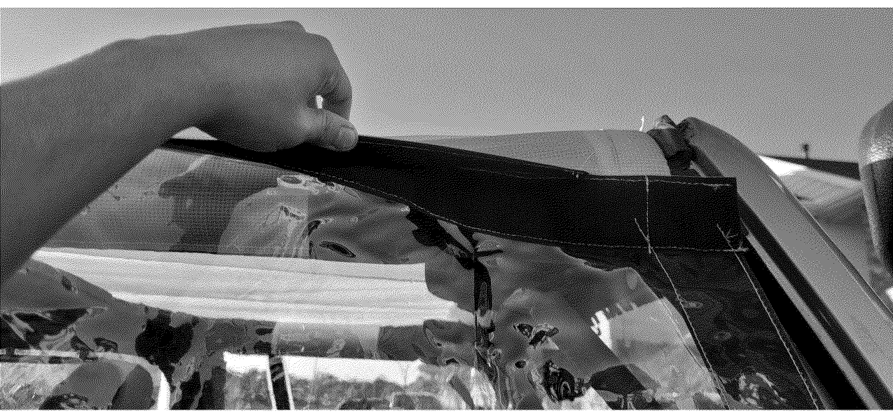

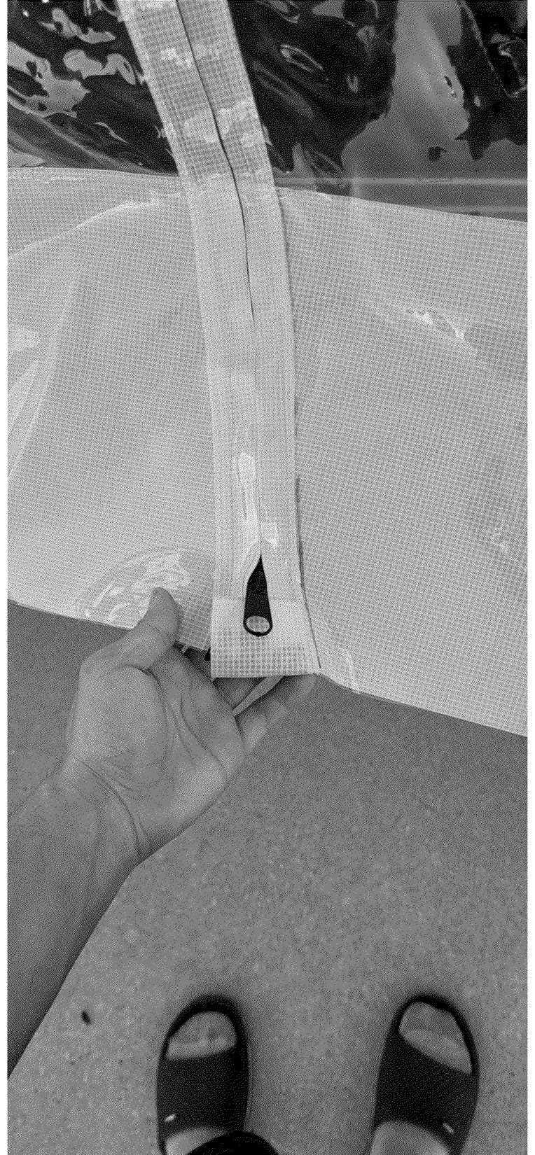

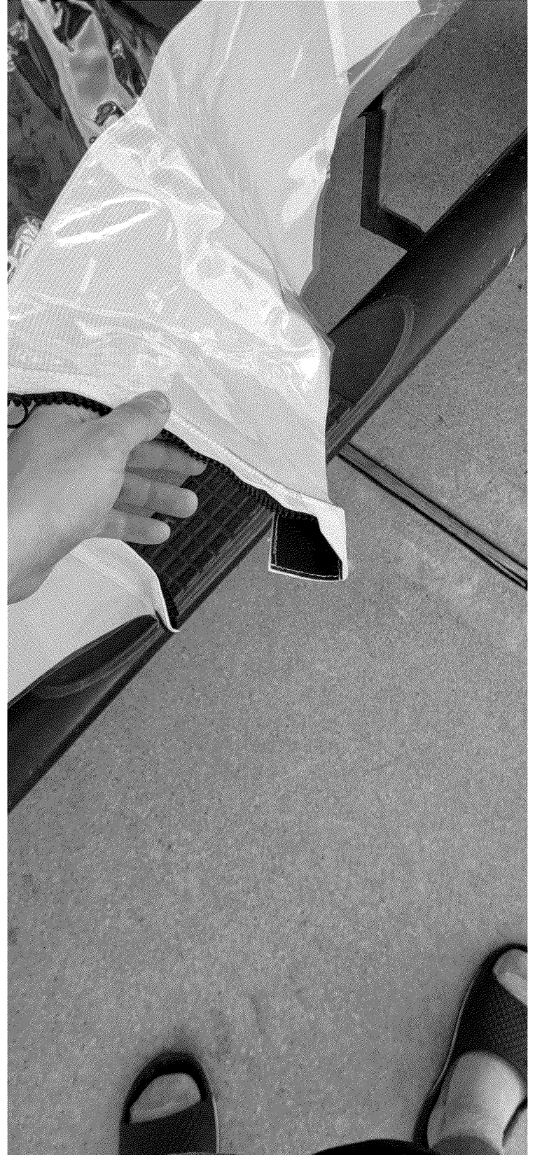

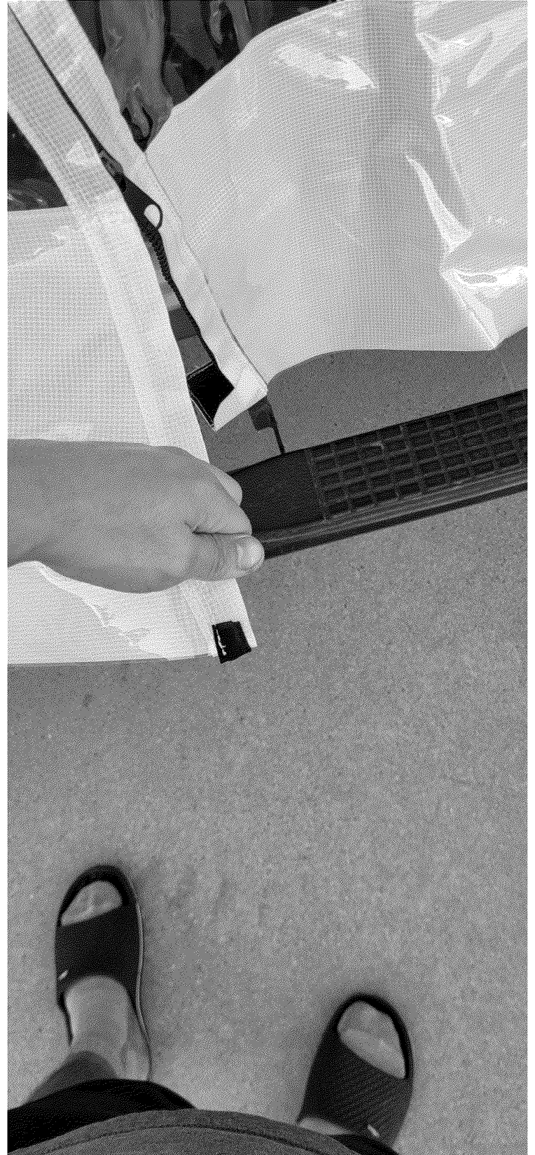

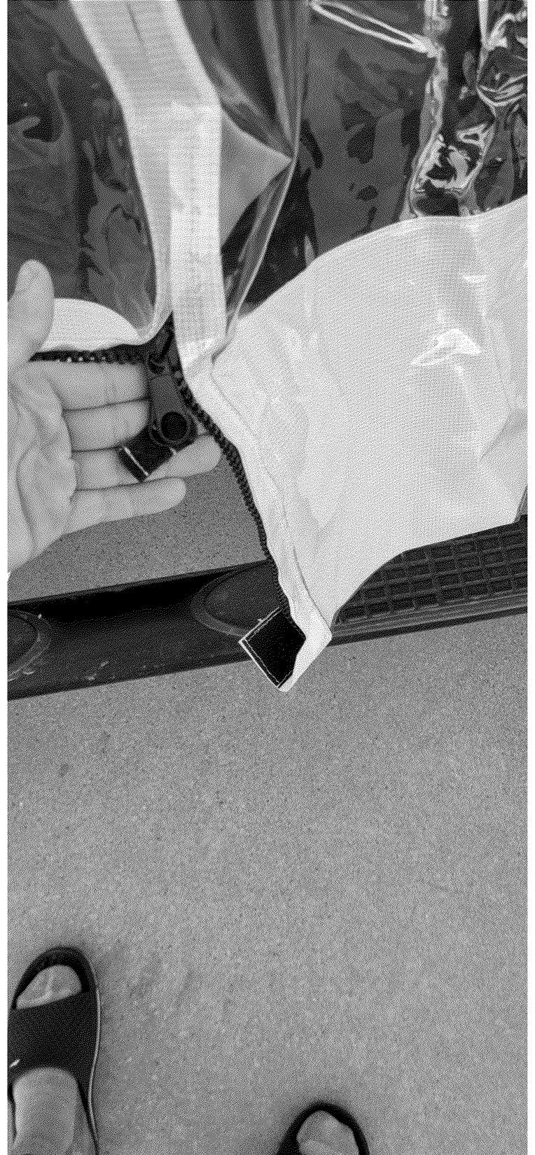

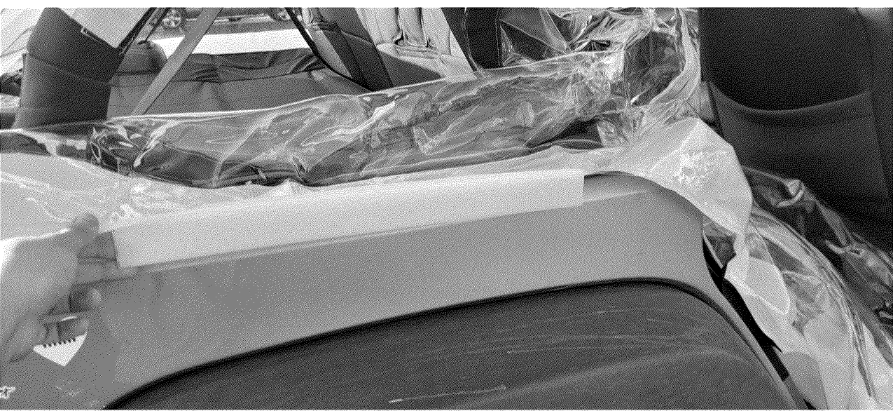

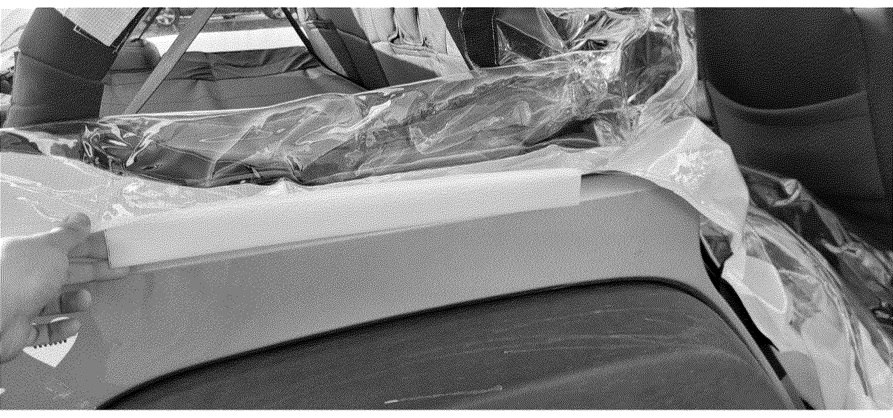

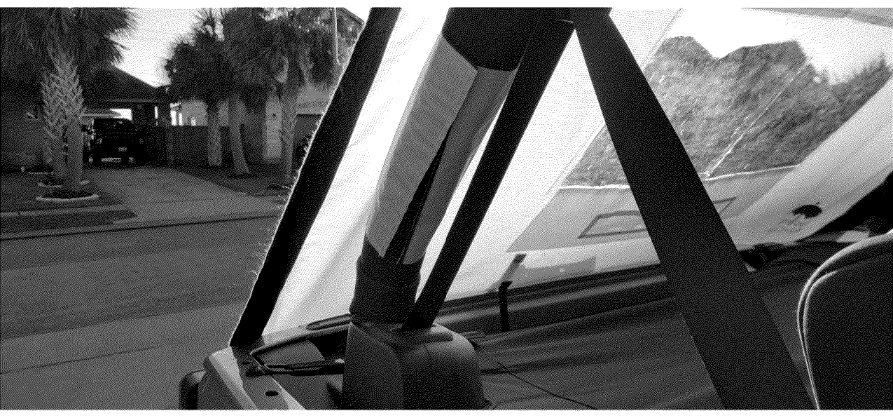

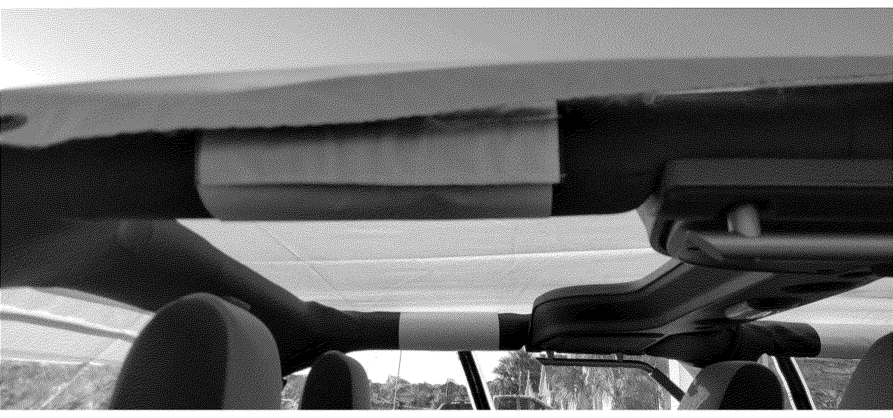

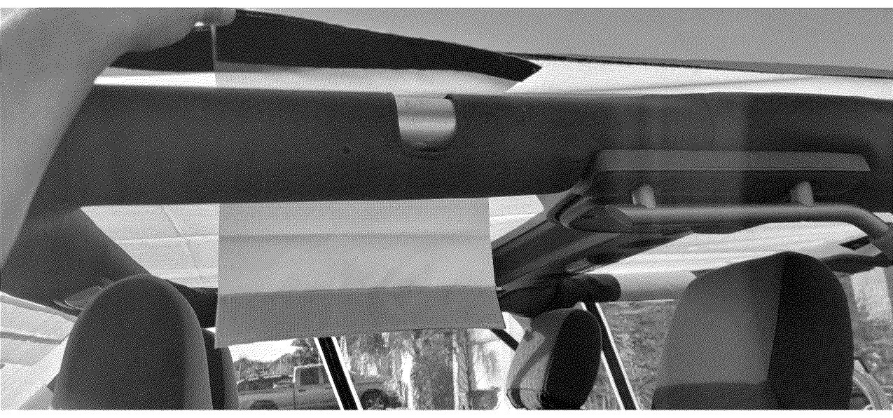

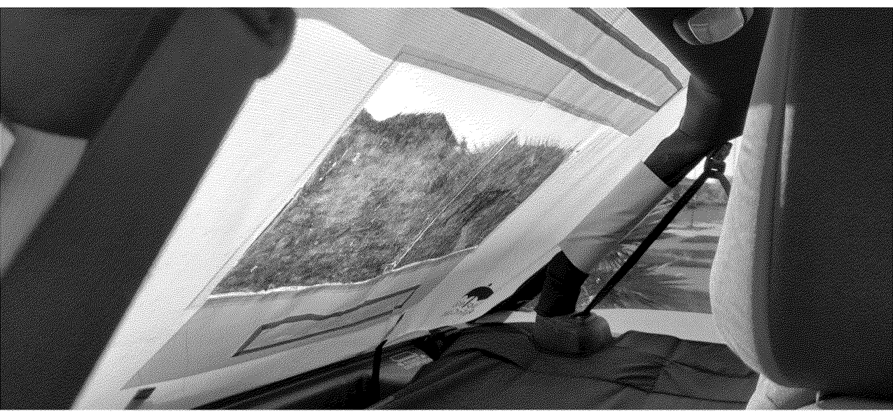

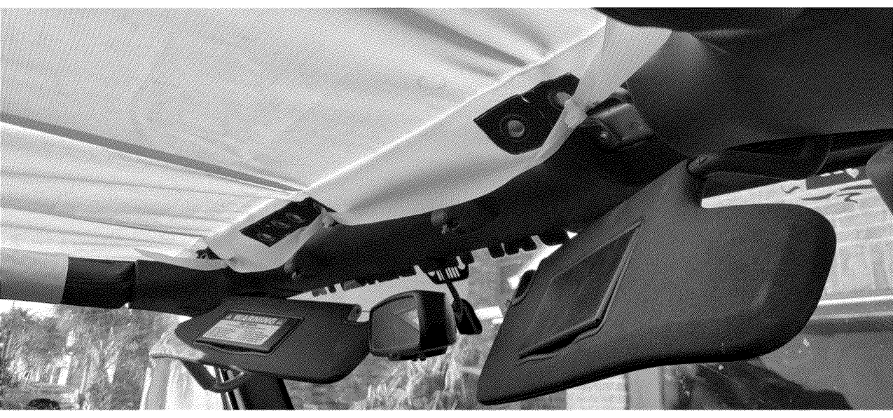

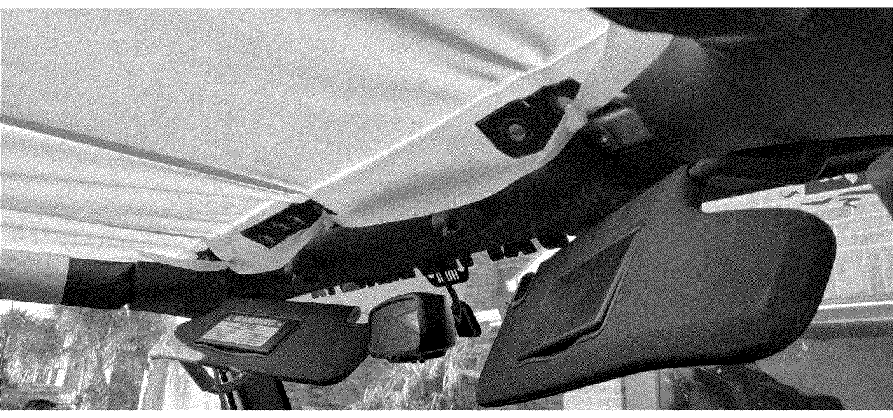

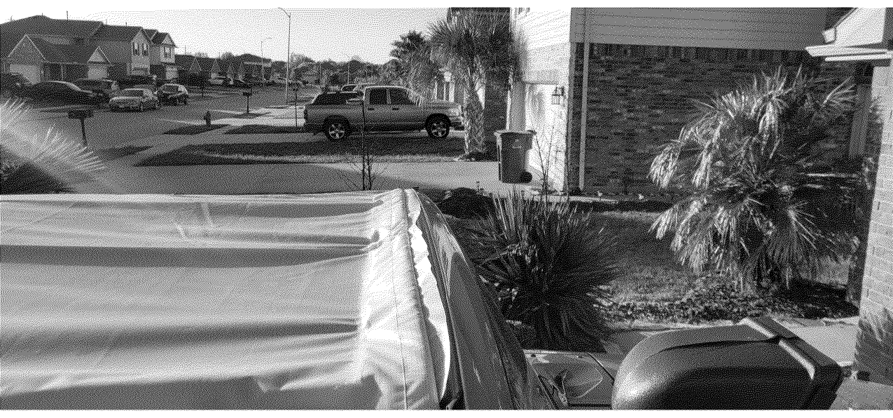

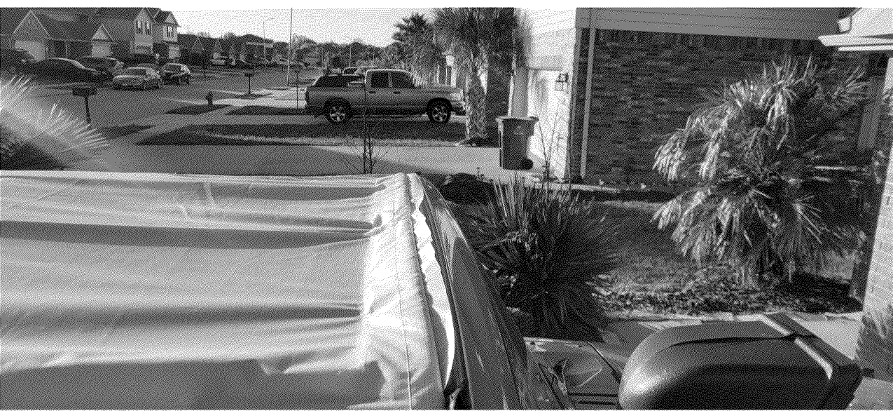

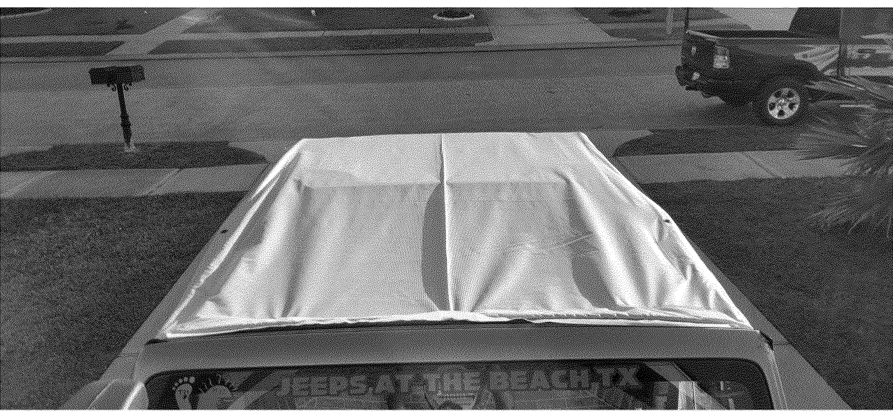

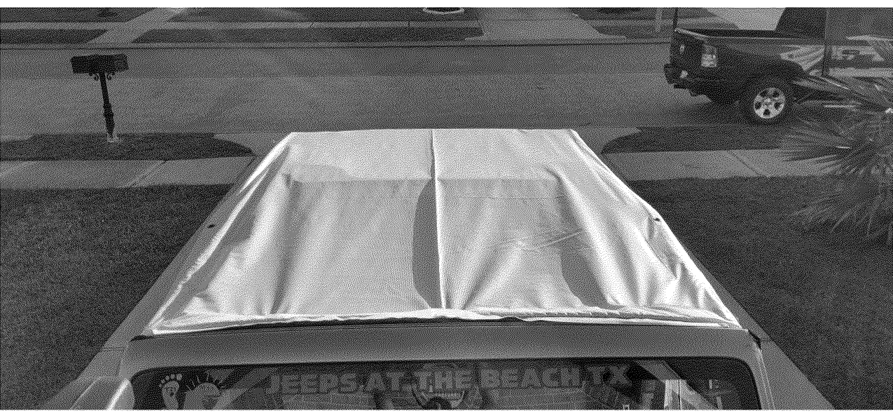

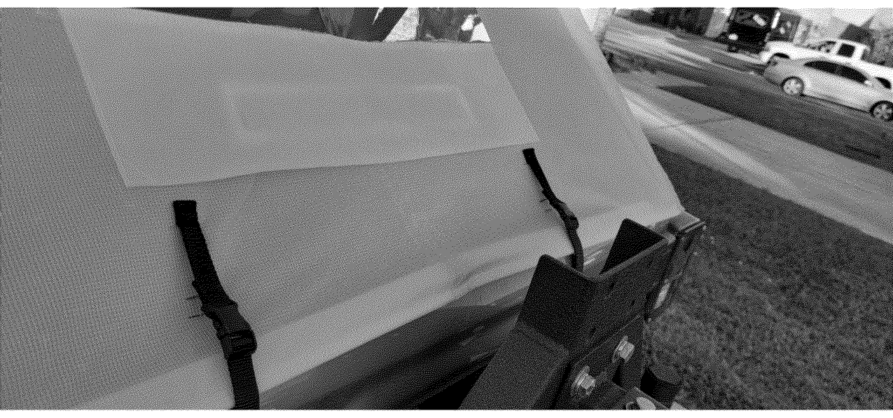

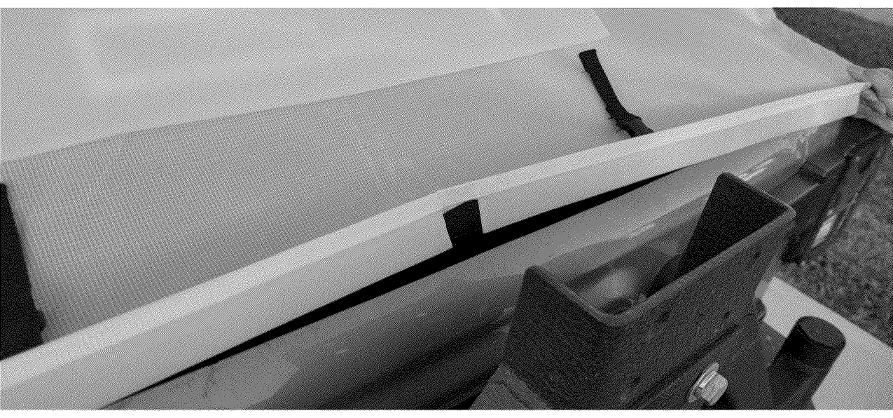

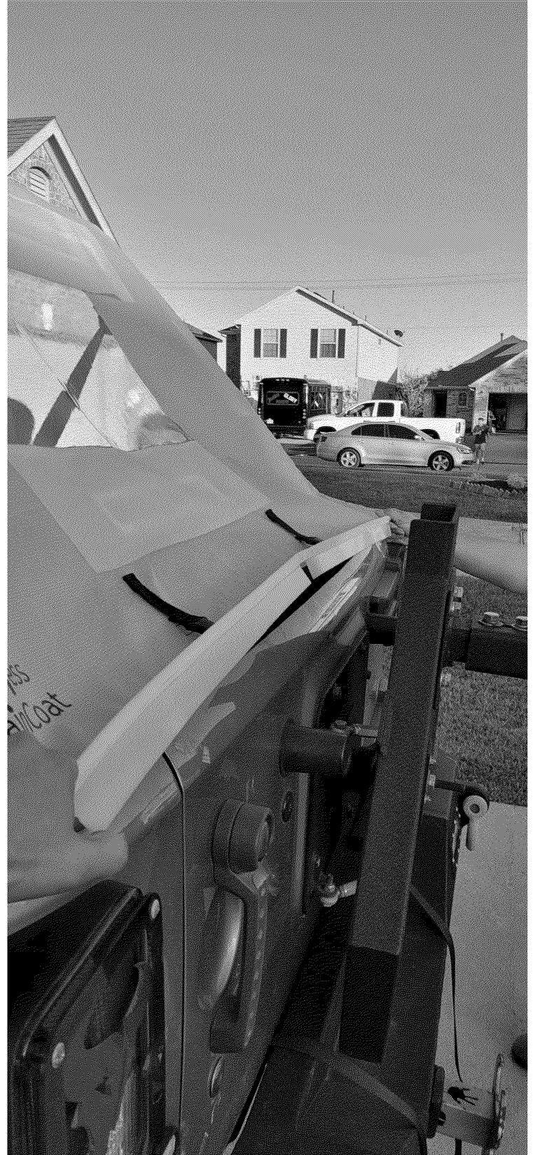

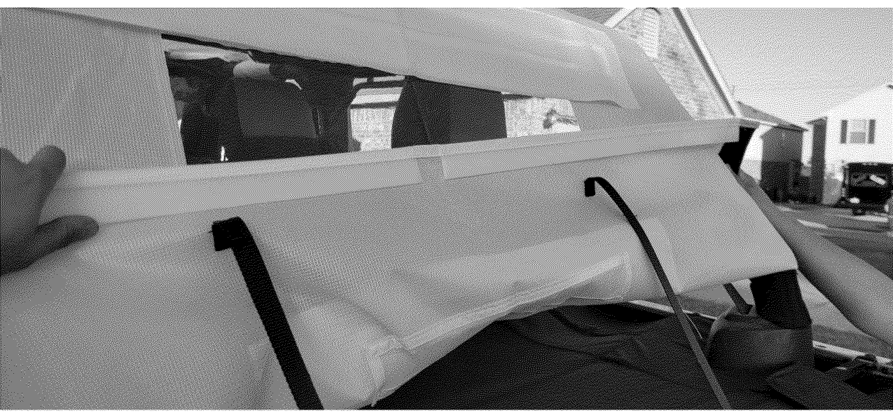

FIG. 8 illustrates a top (exterior) view of a panel that can be attached to a roll bar of the vehicle. FIG. 9 illustrates a bottom (interior) view of the roll bar panel. Attaching the panel to a roll bar secures the cover at the top portion of the vehicle. Roll bar panels can be sewn on to the cover 101 or attached by other means. FIG. 10 illustrates a bottom view of the cover 101 with a plurality of roll bar panels attached. This example shows six roll bar panels but more or less panels can be implemented in the cover system. FIG. 11 illustrates a transparent panel that can be attached to the rear section of the cover 101 to serve as a rear window. FIGS. 12-18 illustrate various views of the cover system 10 and different vehicle attachment points.

The cover system 10 includes many components such as a cover 101, straps, cords, zippers, grommets, and other parts used in installing the cover system 10. The cover 101 is preferably a unitary body that is large enough to cover and protect the top, rear, and sides of a vehicle from being exposed to weather and any environmental elements. The cover 101 comprises a pliable and/or flexible material, enabling the cover 101 to be rolled up and readily stowed (or stored) away. The flexible material can be comprised of plastic, other polymers, fabrics, metal (e.g. transparent aluminum alloy), or any suitable material able to be bent and rolled. Further, the cover 101 is preferably constructed of a durable water resistant material to prevent water from entering the interior of the vehicle. The cover 101 is preferably transparent, enabling occupants to see outside the vehicle. Transparency of the cover 101 allows the vehicle to be driven with the system 10 installed. The cover 101 can be tinted to filter out some sunlight and provide privacy to vehicle occupants. Some parts of the cover can be made of a non-transparent material, to reduce the amount of sunlight entering the vehicle. For example, a top section of the cover could be made of a material that is translucent but not transparent, to protect passengers from excessive sun radiation. Part of the cover that protects the rear of the vehicle can be non-transparent, so long as there is a transparent section that functions as a rear window. The cover system 10 can be stowed in a bag, container, or in a storage area of a vehicle. When a user wants to install the cover system 10, it can readily be accessed and unrolled.

Grommets are included in the cover 101 to retain cords that are used for attaching and securing the cover to the vehicle. The grommets are generally circular rings but can be any shape and size able to retain cords. The grommets prevent the cover 101 from tearing when pulling and attaching cords to brackets, roll bars, and other parts of the vehicle. The grommets can be comprised of plastic, nylon, metal, etc. and are preferably resistant to rust.

A method 500 of installing the cover system 10 is disclosed herein. A user can remove the cover system 10 from a storage location and unroll the cover 101. The user can first install top panels of the cover 101, which are centered on the front windshield. Next, the user can place a cord (e.g. bungee cord, strap, rope) centered on the hooks where the top panels are attached at the top of the front windshield area. Then, install the smaller cords through the grommet holes and attach them to the brackets, tightening them until snug.

Once those cords are installed, ensure that the additional flap is pulled outward and forward toward the hood, before attaching the large hook cord at each side on the top door hinge. Attach the hook from the bottom going upward on the top door hinge bracket. Then, repeat on the other side of the vehicle, and attach that front cord with the hook to the top door hinge where the doors have been removed. The cord hook attaches to the top door hinge and facing upward through the bottom of the hinge hole.

Next, a user can go to the rear of the vehicle. Open the rear gate of the vehicle and allow the straps (e.g. nylon straps), that are sewn to the inside of the white top below the rear window. Allow the straps to hang down toward the outside of the vehicle, shut the tailgate with the straps hanging out. Once the tailgate is shut, Make sure the white top material with the plastic strip is not caught in the door when it is shut. The top cover should be laid on top of the rear door and not get caught in the door. Pull the rear long plastic piece across the back attached to the top piece. Pull the rear long plastic piece outward toward the rear of the vehicle, then flip it underneath the lip located on either side of the tailgate, on the rear fenders of the rear side.

Then, use the straps that are hanging upward to attach to the buckle sewn on either side of the exterior of the top cover and cinch downward but not too tight. Cinch the straps enough to secure it from becoming loose. Then, the user can return to the front passenger side. Use the sewn in flap above the rollbar with a hook-and-loop fastener (e.g. Velcro) to wrap around the roll bar to secure. If a user have a 4 door vehicle, secure the flap for the rear door area. Repeat this process on the driver's side. Now secure the flap on the rear roll bars in the cargo area.

Next, apply the adhesive hook-and-loop fastener pieces provided to the driver's side door jamb at the windshield angle, in order for the sides to adhere in this slanted area. Make sure a user allow the hook-and-loop fastener to stick well before applying the sides. Repeat this step on the passenger side. This hook-and-loop fastener will continuously operate with the cover system 10 and should not be removed when the cover system 10 is not in use.

Then, proceed to unroll the clear vinyl door sides with a hook-and-loop fastener toward the outside of the vehicle, not toward the inside. Once the adhesive Hook-and-loop fastener pieces are securely adhered well in the front door jam on the angled piece of the frame by the windshield on the front driver door and passenger door, start from the front of the vehicle and line up the snaps and hook-and-loop fastener above the door area at the roll bar. Use the hook-and-loop fastener and the snaps to attach the side clear vinyl to the white top piece. Make sure that it is lined up properly from the front windshield to the rear fender, and all the snaps are securely snapped. Go from the front of the vehicle to the rear to attach the sides to the top. Repeat this step for the other side. Make sure that the hook-and-loop fastener on the front by the windshield of the side clear vinyl panel is attached to the front door jamb just above the door hinges on both sides of the vehicle.

Next, use the cord that is already in place on the hinge bracket. Remove it and use it to go through the clear vinyl side panel piece where there are slots precut for the hinges. Hook to the bottom of the top door hinge slot of the top hinge with the hook using the cord hook to hold the top hinge in place side in the door hinge.

Use the provided tie chords to thread through both door hinge holes from the outside, go through the top one and bottom one for the doors to attach the side clear vinyl panel There are precut slots holes at the hinge location to attach the clear vinyl plastic sides. Do the same if there is a back door for a 4 door vehicle. Tie the two ends to secure on the outside of the vehicle.

Next, use the plastic piece provided sewn to the bottom of the clear vinyl side panel above the rear Fender to secure over the rear fender. There is a metal lip. The Plastic piece flips underneath the lip in order to secure it above the right rear fender. The cover system 101 should be secured and in place now. Cinch the back straps again to ensure they are secure. There are additional provided bungie balls to use around the roll bars on either side through the provided grommets. The clear vinyl sides can roll up as an awning would in order to not have to put them away but these are optional.

Before stowing (or storing) the cover system, make sure everything is very dry once removed. Lay the vinyl clear panels on top of each other and then on top of the white top panel. Fold in half the long way. Roll the cover 101 from one end to the other and place in the provided bag for storage in the vehicle.

In another embodiment, a cover system 20 provides protection from environmental elements when the vehicle 60 has all its doors, windows, and rooftop removed. There are several additional features included in cover system 20. The cover system 20 includes extra rip stops to help stiffen and re-enforce portions of the system 20 with structural weaknesses. The cover system 20 further includes vents to relieve pressure from the vehicle cabin and ensures the top cover does not lift up while driving. Protective sealant can be implemented on sew lines to prevent leaks in the system 20. Additional grommets can be included to assist with usability. In contrast to cover system 10, snaps are not implemented as fasteners in cover system 20. The system 20 includes mounting points for door hinges to secure the sides of the cover system 20 to the vehicle 60.

A method 600 of installing the cover system 20 is disclosed. Prior to installation (pre-installation step), remove the cover system 20 from its packaging and allow it time to stretch (straighten) out. This can be accomplished by laying on a flat surface in direct sunlight or by laying it over the vehicle. This step is of course unnecessary if the cover system 20 is already stretched out. While the cover system 20 stretches out, a user can apply hook-and-loop-fasteners to the vehicle to ensure proper function of the cover system (NOTE: make sure to clean and dry the areas where the hook-and-loop-fastener is applied to the vehicle. Apply the second longest strip of hook-and-loop-fastener (16.5 inch) to the top of the “A” pillar approximately 1 inch over the black trim piece. Apply the longest strip of hook-and-loop-fastener (20 inch) to the inside of the door frame, to the right of the front door hinges half an inch under the black door seal. Apply the smallest hook-and-loop-fastener strip (4 inch) 1 inch under hook-and-loop-fastener strip B following the body line. Next, apply the third smallest hook-and-loop-fastener strip (10.5 inch) above the rear fender approximately 1 to 1.5 inches under the bend following the body line above the fender. Next, repeat the aforementioned steps on the opposite side of the vehicle. A user may also take this time to make sure the vehicle is free of any modifications that could interfere with the cover system functionality. The cover system fits properly when the vehicle has the hard/soft top removed and the doors. It is advisable for a user to completely remove the hard/soft top and doors prior to installation.

Following the pre-installation step, the top portion of the cover system 20 can be installed. Spread the cover system over the top of the vehicle ensuring that the long bungee is at the front of the vehicle and the Plastic Tabs and Window are at the back. Use the roll bar wraps to align and secure the cover system to the roll bars. Align the front bungee and front flap into the groove of the weatherproofing above the windshield, making sure that both sides have an even amount of vinyl hanging from the weatherproofing. Pull the bungee first outward then downward to hook onto the top door hinge. Then repeat on the opposite side. (NOTE: the bungee and the front flap should now be tight along the weatherproofing. Also make sure the top is properly centered and in the groove). Next, using the provided zip ties or any large high strength zip ties. Loop the zip ties through the grommet holes and the soft top mounting brackets to secure the front of the cover system to the vehicle. Next open the vehicle tailgate and drape the nylon webbing out of the vehicle, ensuring the nylon webbing is straight and free of kinks. Slightly lift the at the folding point then close the tailgate ensuring that the nylon webbing is flat and not kinked on the inside. Using the plastic boning on the back of the cover system, flip the tab under the metal lip to tighten the whole top. Connect the plastic buckles on the outside to each other and pull down to tighten.

Following the installation of the top portion, the sides of the cover system 20 can be installed. First, a user aligns the center bar to the center of the “B” pillar. The left side or side closest to the front of the vehicle should line up with the center B pillar. Next, attach the hook-and-loop-fastener starting at the center to the back just before the bend. Starting at the center of the rear section, apply the hook-and-loop-fastener towards the rear. Next, from the center of the rear section apply the hook-and-loop-fastener until a user can create a crease in the top. Then, just like on the rear side, push the plastic boning under the metal lip above the fender to secure the rear of the sides. Next, attach the rest of the hook-and-loop-fastener from the B pillar to the front of the vehicle. (NOTE: the bungee attached to the door hinge may need to be removed during this step to fully secure the hook-and-loop-fastener.) Next, attach the provided tabs to the door hinges to provide extra security. This can be done with the supplied shoe lace or zip ties. Next, attach the hook-and-loop-fastener to the inside of the frame sealing the top. Next, repeat the aforementioned steps on the opposite side of the vehicle.

1. A vehicle cover system comprising:
a) a top cover;
b) a transparent rear side;
c) a transparent first side;
d) a transparent second side; and
e) wherein the vehicle cover system is comprised of a waterproof material.
